(19) United States
(12) Patent Application Publication
(10) Pub. No.: US 2004/0158853 A1
(43) Pub. Date: Aug. 12, 2004

(54) Method of selecting televisual programs, audiovisual apparatus for presenting televisual programs, and apparatus for providing additional services

(76) Inventors: Miwako Doi, Kawasaki-shi (JP); Osamu Hori, Yokohama-shi (JP); Kazuo Sumita, Yokohama-shi (JP); Hideki Hirakawa, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/773,166

(22) Filed: Feb. 9, 2004

Related U.S. Application Data
(63) Continuation of application No. 09/386,295, filed on Aug. 31, 1999.

(30) Foreign Application Priority Data
Sep. 30, 1998 (JP) 10-279076

(51) Int. Cl. H04N 5/445; G06F 3/00; G06F 13/00

(52) U.S. Cl. 725/38; 725/40; 725/39; 725/61

(57) ABSTRACT

An audiovisual apparatus for presenting televisual programs includes a reception section for receiving an EPG (Electronic Program Guide) in which televisual programs to be provided are classified into categories according to tastes of users to allow selection of the televisual program in accordance with the categories together with contents information of a televisual program or independently of the contents information, a generation section for generating a program selection window for selecting a desired program in accordance with the categories on the basis of the EPG received by the reception section, and a selection section for selecting a televisual program to be reproduced or recorded from the program selection window.

### BACKGROUND OF THE INVENTION

This application is based on Japanese Patent Application No. 10-279076, filed Sep. 30, 1999, the contents of which are incorporated herein by reference.

The present invention relates to broadcasting services, and more particularly to a method of selecting televisual programs, an audiovisual apparatus for presenting televisual programs, and an apparatus for providing additional services, which enable users to easily select whichever televisual programs they want and which provide the users additional services.

More and more TV programs are presented through well over one hundred channels, by means of cable television, digital satellite TV broadcasting, and the like. When only few TV channels were available, it was sufficient for a user to switch over the channels until he or she got the desired channel. Now that more than 100 channels are in service, it would take the user, in most cases, until he or she selects the very channel he or she desires. To enable the user to get the desired channel quickly, audiovisual navigation systems, such as EPG (Electronic Program Guide) has been proposed.

Two types of EPG have been proposed. The first type EPG describes program information in the form of a text (HTML: HyperText Markup Language, or the like). The second type EPG describes program information in the form of a multimedia image (MHEG-5, Expanded HTML, or the like). The EPG is multiplexed, along with video data and audio data, on digital broadcasting waves. The digital broadcasting waves are transmitted from the broadcasting station. In any digital TV receiver that has received the waves, the EPG is extracted from the waves and processed. The digital TV receiver therefore displays a navigation image.

The EPG is incorporated into the digital broadcasting waves in the broadcasting station. It is not guaranteed that the program the user wishes to enjoy is presented at first on the TV screen. Assume that the user wants to see a music show in which “Taro Yamada” will sing. Also assume that Station A is broadcasting spaghetti westerns this month and a program menu showing the spaghetti westerns is displayed on the TV screen when the user tunes in to Station A. On the other hand, assume that Station B is broadcasting special programs of soccer as a prelude of the World Cup Soccer, a program guide for the specials or associated programs is displayed at first. To see the music show of “Taro Yamada”, the user must search some program menus because the program guide for music shows is displayed at first in neither Station A nor Station B.

Most televisual programs a user daily watches are regular programs. However, a “features” guide provided in the EPG introduces only programs for the convenience of the broadcasting station. In addition, the user cannot select the regular programs unless he or she watches the “features” guide in the EPG first, so the number of times of operations increases.

A broadcasting station produces a “features” guide at high cost and therefore wants to promote it, though it does not always meet the user's taste.

In the conventional method, the number of user's operations of selecting a desired program increases because the EPG aims at audiovisual navigation regardless of the user's taste.

In addition, the contents of feature (recommended) programs for the convenience of a broadcasting station become stereotyped.

### BRIEF SUMMARY OF THE INVENTION

It is an object of the present invention to provide a method of selecting televisual programs and an audiovisual apparatus for presenting televisual programs, which allow a viewer to easily select a televisual program meeting his or her taste by only a simple operation of selecting a desired category for the viewer's taste and selecting a desired program from the selected category.

It is another object of the present invention to provide an apparatus for providing additional services, which can provide additional services that allow a viewer to easily select a televisual program distributed by broadcasting in accordance with the taste of the viewer.

In order to achieve the above objects, according to the first aspect of the present invention, there is provided a method of selecting televisual programs, comprising the steps of: generating a program selection window for causing a viewer to select a desired program in accordance with categories on the basis of EPG in which televisual programs to be provided are classified into the categories according to tastes of viewers to allow selection of a televisual program in accordance with the categories; and causing the viewer to select a televisual program to be reproduced or recorded from the program selection window.

According to the second aspect of the present invention, there is provided an audiovisual apparatus for presenting televisual programs, comprising: reception means for receiving EPG in which televisual programs to be provided are classified into categories according to tastes of viewers to allow selection of a televisual program in accordance with the categories together with contents information of the televisual program or independently of the contents information; generation means for generating a program selection window for causing the viewer to select a desired program in accordance with the categories on the basis of the EPG received by the reception means; and selection means for causing the viewer to select a televisual program to be reproduced or recorded from the program selection window.

According to the third aspect of the present invention, there is provided an apparatus for providing additional services for televisual programs to be, distributed by broadcasting, comprising: electronic program guide (EPG) generation means for generating EPG in which televisual programs to be provided are classified into categories according to tastes of viewers to allow selection of a televisual program in accordance with the categories; and update means for updating the EPG on the basis of a similarity between televisual programs selected by the viewers.

According to the fourth aspect of the present invention, there is provided an article of manufacture comprising: a computer usable medium having computer readable program code means embodied therein for causing a viewer to select a televisual program to be provided, in accordance with a taste of the viewer, the computer readable program code means in the article of manufacture comprising: computer readable program code means for causing a computer to receive an electronic program guide (EPG) in which televisual programs to be provided are classified into categories according to tastes of viewers to allow selection of a televisual program in accordance with the categories; computer readable program code means for causing the computer to generate a program selection window for causing the viewer to select a desired program in accordance with the categories on the basis of the received EPG; and computer readable program code means for causing the computer to select a televisual program to be reproduced or recorded from the program selection window.

According to the present invention, by only a simple operation of selecting a desired category meeting the taste of a viewer and selecting a desired program from the selected category, the viewer can easily select a televisual program meeting his or her taste from a variety of televisual programs provided by a plurality of program providers through many channels.

Additionally, according to the present invention, EPG to be distributed to each viewer is appropriately updated by adding televisual programs selected by another viewer having a taste similar to that of the viewer. For this reason, televisual programs classified into categories are prevented from becoming stereotyped.

Furthermore, according to the present invention, since EPG for the viewer is appropriately updated in accordance with not only televisual programs selected by the viewer but also the taste of the viewer, which is extracted from information associated with goods or tickets purchased by, e.g., mail orders, televisual programs classified into categories are prevented from becoming stereotyped.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the overall arrangement of a broadcasting system according to the first embodiment of the present invention;

FIG. 2 is a block diagram showing a detailed arrangement of an audiovisual apparatus shown in FIG. 1;

FIG. 3 is a view showing an example of an electronic program guide (EPG) provided by an EPG providing apparatus shown in FIG. 1;

FIGS. 4A and 4B are flow charts showing processing of the audiovisual apparatus shown in FIG. 2;

FIG. 5 is a view showing an example of a program guide window generated by a window generation unit shown in FIG. 2;

FIG. 6 is a view showing an example of a program list generated from information associated with televisual programs belonging to a category selected on the program guide window shown in FIG. 5;

FIG. 7 is a block diagram showing another arrangement of the broadcasting system;

FIG. 8 is a block diagram showing a detailed arrangement of an audiovisual apparatus shown in FIG. 7;

FIG. 9 is a system block diagram showing another arrangement of the audiovisual apparatuses shown in FIGS. 2 and 8;

FIGS. 10A and 10B are flow charts showing processing of the audiovisual apparatus shown in FIG. 9;

FIG. 11 is a view showing an example of a program guide window generated by the audiovisual apparatus shown in FIG. 9;

FIG. 12 is a view showing still another arrangement of the audiovisual apparatus;

FIG. 13 is a view showing a detailed arrangement of a personal authentication unit;

FIG. 14 is a block diagram showing the arrangement of a broadcasting system according to the second embodiment of the present invention;

FIG. 15 is a block diagram showing details of an audiovisual apparatus shown in FIG. 14;

FIG. 16 is a view schematically showing an example of contents of an EIT (Event Information Table) used by a similar program calculation unit of an EPG providing apparatus;

FIG. 17 is a flow chart showing program similarity calculation processing executed by the similar program calculation unit of the EPG providing apparatus;

FIG. 18 is a view showing an example of presentation of new recommended programs selected by program similarity calculation processing in the audiovisual apparatus; and

FIG. 19 is a view showing the arrangement of a broadcasting system which uses product purchase record by communication to determine the tastes of viewers.

### DETAILED DESCRIPTION OF THE INVENTION

Embodiments of the present invention will be described below with reference to the accompanying drawing.

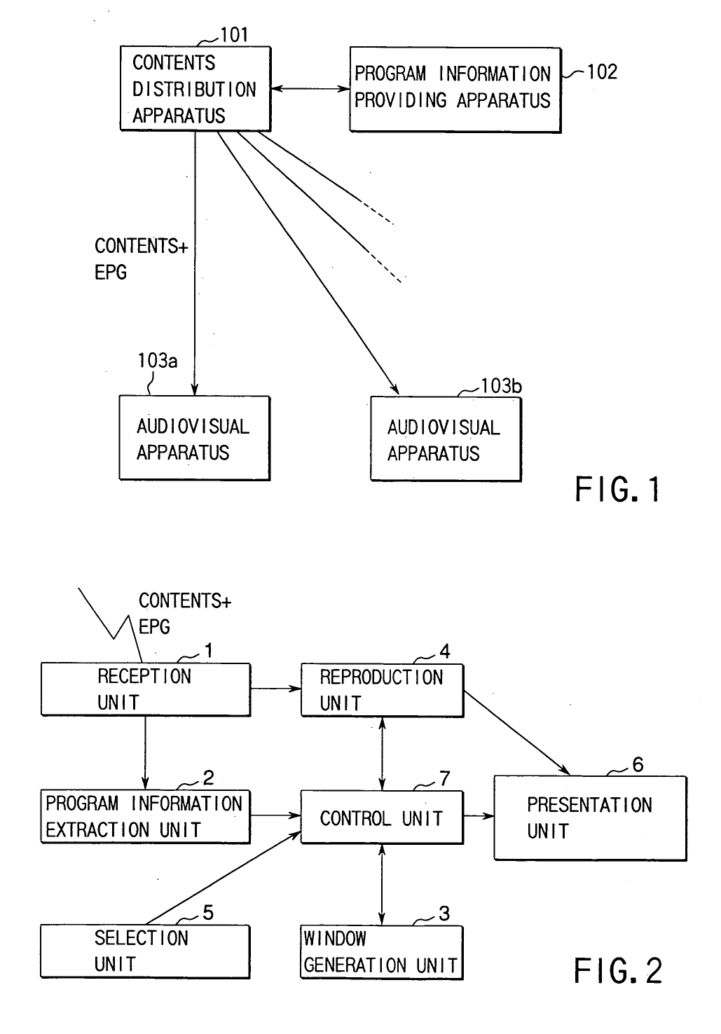

FIG. 1 shows the overall arrangement of a broadcasting system according to the first embodiment. An electronic program guide (EPG) providing apparatus 102 collects contents (video data and audio data) distributed from a plurality of broadcasting stations by broadcasting or event information (EIT: Event Information Table) belonging to the contents or keyword information associated with the contents of televisual programs, analyzes the attached information to generate an electronic program guide (EPG: Electronic Program Guide), and transmits the generated EPG to a contents distribution apparatus 101 through, e.g., a predetermined communication line. A specific example of the EPG providing apparatus 102 is a provider for providing Internet services. The contents distribution apparatus 101 multiplexes the EPG generated by the EPG providing apparatus 102 on the contents of televisual programs (video data and audio data) and distributes it to audiovisual apparatuses 103a and 103b by ground or satellite waves. As the contents distribution apparatus 101, a cable TV company or digital satellite broadcaster is exemplified. The audiovisual apparatuses 103a and 103b are set in the houses of viewers subscribed to the services of the broadcasting system. For the illustrative convenience, only one contents distribution apparatus 101 is shown in FIG. 1. Actually, a plurality of contents distribution apparatuses are set in correspondence with the plurality of broadcasting stations. The contents and EPGs are distributed from the contents distribution apparatuses to the program receiving apparatuses of the viewers who have subscribed to reception by broadcasting.

FIG. 2 shows an arrangement of the audiovisual apparatus shown in FIG. 1. The audiovisual apparatus comprises a reception unit 1 for receiving a broadcasting wave on which the EPG and contents information distributed from the contents distribution apparatus 101 are multiplexed, an EPG extraction unit 2 for extracting an EPG from the broadcasting wave, a window generation unit 3 for generating a program guide window (program selection window) on the basis of the extracted EPG, a selection unit 5 for selecting a televisual program from the generated program guide window, a reproduction unit 4 for extracting the contents of the televisual program selected by the selection unit 5 from the broadcasting wave received by the reception unit 1 and reproducing the contents, a presentation unit 6 for presenting the program guide window generated by the window generation unit 3 or contents reproduced by the reproduction unit 4, and a control unit 7 for controlling the operations of the respective units.

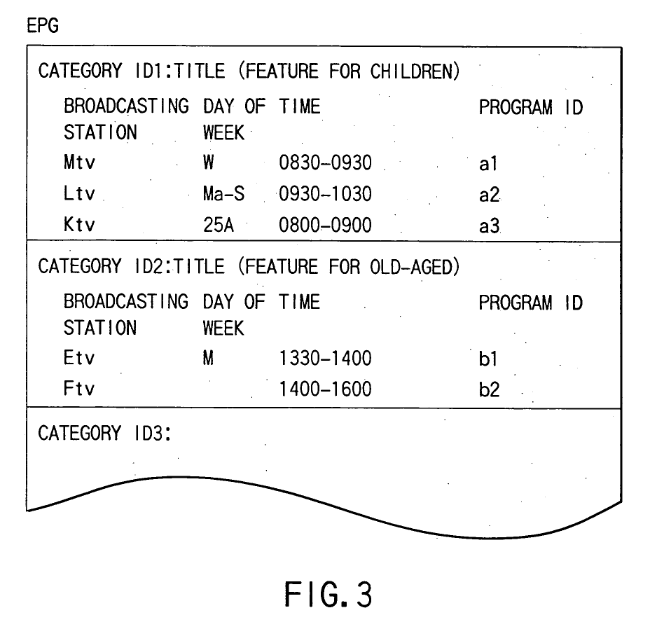

An EPG is an electronic program guide in which televisual programs individually provided from a plurality of broadcasting stations (program providers) are classified into categories corresponding to the tastes of viewers (for example, categories corresponding to ages and sexes: “for fathers”, “for children”, “for old-aged, and the like), as shown in FIG. 3. Each viewer selects a televisual program from a desired category using the EPG. In use of the EPG, a viewer selects a category and then a desired program in the selected category with this operation, the contents of the televisual program can be reproduced from a broadcasting wave from the broadcasting station that provides the selected program. A televisual program can be easily selected, unlike the prior art in which a broadcasting station is selected first, and the program guide of the broadcasting station is, searched for a televisual program.

FIG. 3 shows a specific example of the EPG. Televisual programs provided from a plurality of broadcasting stations (e.g., Mtv, Ltv, Etv, and Ftv) are classified into categories such as “for children” and “for old-aged”, and identifiers (program IDs) for uniquely identifying a televisual program, broadcasting station, a day of the week, and time are described.

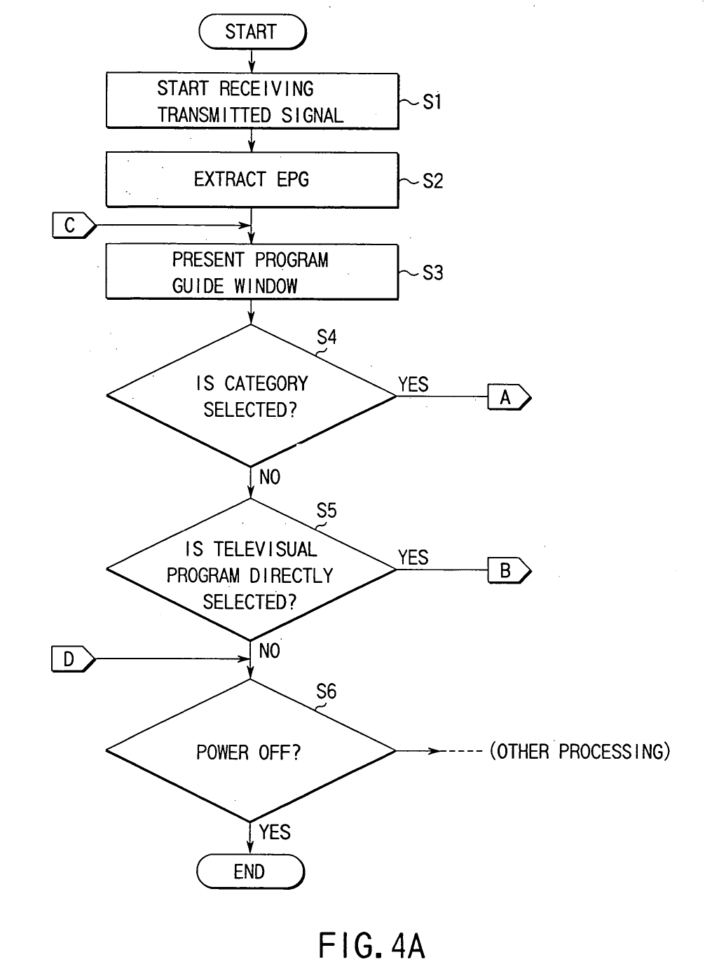

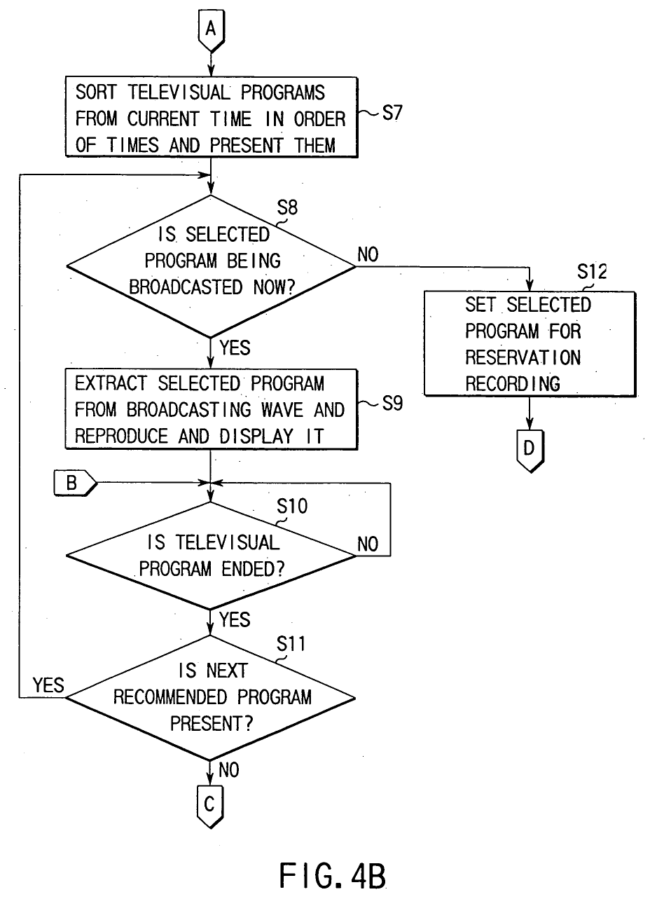

FIGS. 4A and 4B are flow charts for explaining processing of the audiovisual apparatus shown in FIG. 2.

When the audiovisual apparatus is powered on, the reception unit 1 starts receiving a broadcasting wave (step S1). The EPG extraction unit 2 extracts, an EPG from the received broadcasting wave (step S2). For example, the broadcasting wave contains compressed (encoded) EPG as shown in FIG. 3, and the EPG extraction unit 2 extracts the EPG and decodes it.

In the EPG shown in FIG. 3, the category with an identifier “category ID1” collects televisual programs recommendable for children, so a program guide with a title “feature for children” is generated. The first line of this category describes program data “Mtv W 0830-0930 a1”. This means that the televisual program will be broadcasted by broadcasting station “Mtv” “0830-0930” (8:30-9:30) on “W” (Wednesday), and the program ID is “a1”. The program ID is an identifier for uniquely identifying the televisual program. Program data belonging to the same category are described from second line. No description in “day of the week” of the program data means that the televisual program will be broadcasted at that time every week. “M-Sa” means that the televisual program will be broadcasted from Monday to Saturday. “25A” means that the televisual program will be broadcasted only April 25.

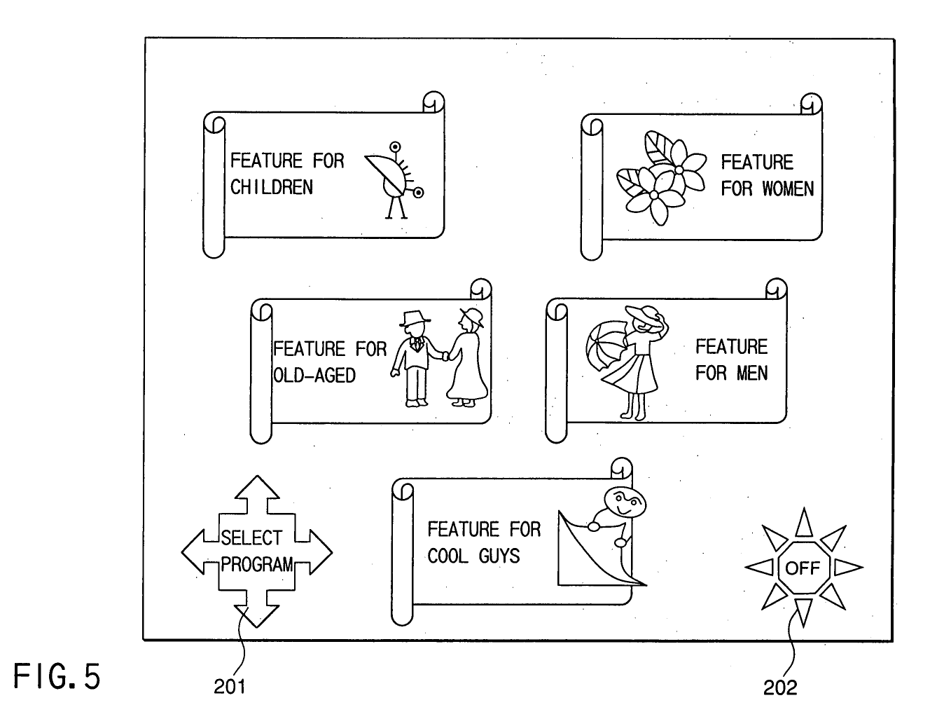

The window generation unit 3 generates a program guide window as shown in FIG. 5 on the basis of the EPG extracted by the EPG extraction unit 2 and presents it on the presentation unit 6 (step S3).

In the program guide window shown in FIG. 5, all categories (“feature for children”, “feature for old-aged”, “feature for women”, “feature for men”, and “feature for cool guys”) in the EPG shown in FIG. 3 are laid out as images for selection. In this case, categories based on ages/sexes have been exemplified. However, the present invention is not limited to this.

For example, categories based on genres such as “feature for sport fans”, “feature for booklovers”, and “feature for movie fans” may be used. Alternatively, a specific genre may be further classified into categories such as “feature for soccer fans” and “feature for baseball fans”.

A viewer selects the image of a category of his or her interest from the program guide window presented on the presentation unit 6 using the selection unit 5 such as a remote controller (step S4).

To see a desired program without selecting it from the program guide window, the viewer can operate a program selection button 201 at the lower left corner of the program guide window using the remote controller to end display of the program guide window and directly select the desired program, as in the prior art (step S5).

For example, to stop watching a televisual program because no interesting categories are presented on the program guide window, the operation of the audiovisual apparatus can be forcibly ended by operating an “off” button 202 at the lower right corner of the program guide window by the remote controller or depressing the power-off button on the remote controller (step S6).

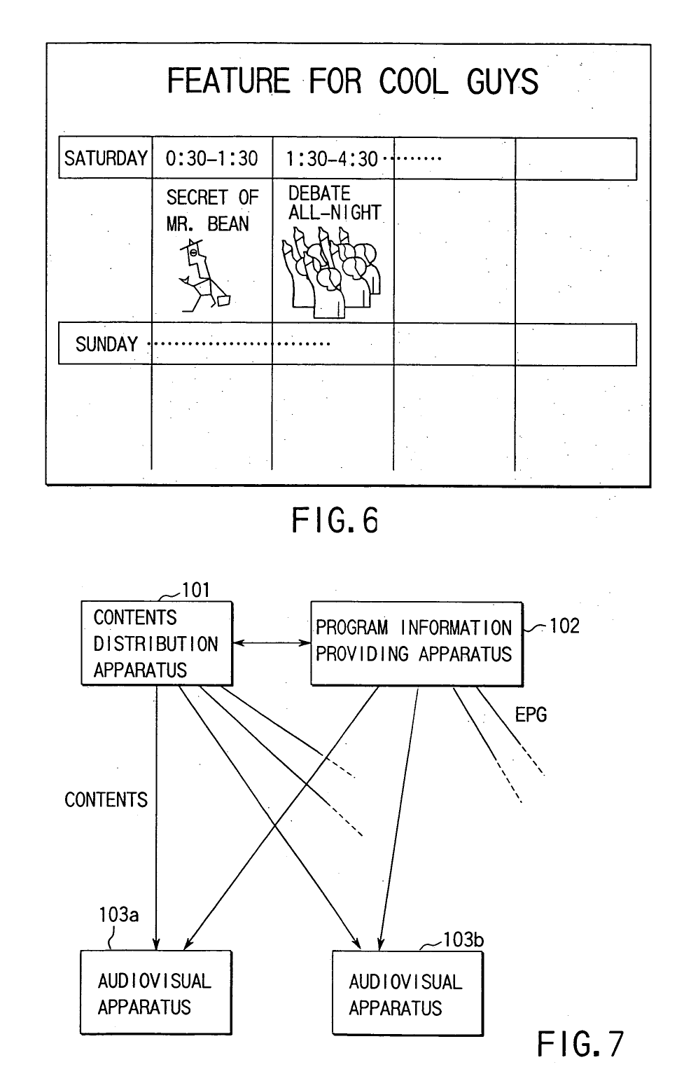

When a category is selected from the program guide window in step S4, the window generation unit 3 resorts program data classified into the category in the order of broadcasting times on the basis of EPG as shown in FIG. 3 to generate the recommended program list of televisual programs belonging to the category, as shown in FIG. 6, and presents the recommended program list on the presentation unit 6 (step S7).

FIG. 6 shows a recommended program list of televisual program classified into the category “feature for cool guys”. A televisual program can be directly selected on the recommended program list using the presentation unit 6 such as a remote controller. Since some televisual programs have already been broadcasted, it is preferable to generate a recommended program list on the basis of program data that will be broadcasted from the current time. Assume that the current time is 0:35 in Saturday morning. In this case, televisual programs from 0:30 in Saturday morning are presented.

The viewer sequentially checks the recommended program list as shown in FIG. 6, which is presented on the presentation unit 6, from the current time and selects a desired program from the recommended program list using the selection unit 5 (e.g., remote controller). Assume that the viewer selects “Secret of Mr. Bean” at the start of recommended program list shown in FIG. 6. If the current time is 0:35 in Saturday morning, the televisual program is already being broadcasted (step S8). Immediately, the reception unit 1 extracts the contents (including video and audio data) of the selected program, and the reproduction unit 4 reproduces the contents of the televisual program and presents the contents on the screen of the presentation unit 6 (step S9).

When the televisual program is ended (step S10), and any other televisual program belonging to the selected category will be or is already being broadcasted (step S11), the flow advances to step S8 to reproduce the contents of the televisual program. That is, when a televisual program belonging to the selected category is being broadcasted, the contents are continuously reproduced such that the viewer can watch the televisual program.

If NO in step S11, the flow returns to step S3 to present the program guide window such that the viewer can select a category or televisual program or power off the audiovisual apparatus.

If NO in step S8, program data of the televisual program in the EPG may be set for reservation recording such that the viewer can absolutely watch the televisual program (step S12).

As described above, according to the first embodiment, the audiovisual apparatus receives EPG in which televisual programs broadcasted by a plurality of broadcasting stations and classified into categories corresponding to the tastes of viewers, generates a program guide window on the basis of the EPG, and presents the program guide window. The viewer can watch a desired program and reserve recording by only a simple operation of selecting a desired category from the program guide window and selecting the desired program from the selected category.

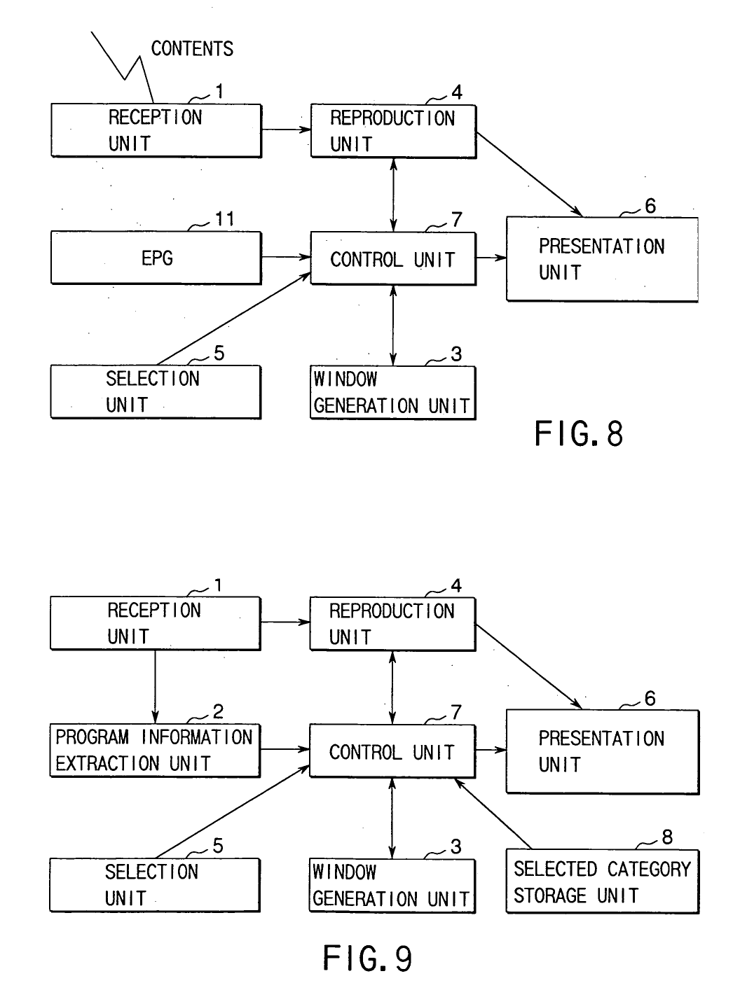

In the first embodiment, the contents of televisual programs and EPG are multiplexed and broadcasted. However, the present invention is not limited to this, and the contents of televisual programs and EPG may be independently distributed. For example, as shown in FIG. 7, only EPG may be distributed from the EPG providing apparatus 102 independently of the contents of televisual programs. Alternatively, EPG may be recorded on a recording medium such as a DVD-ROM or floppy disk and distributed to viewers. In this case, each of the audiovisual apparatuses 103a and 103b has an EPG acquisition unit 11 in place of the EPG extraction unit 2 in FIG. 2, as shown in FIG. 8. The reception unit 1 receives a broadcasting wave containing the contents of televisual programs except EPG.

The EPG acquisition unit 11 receives EPG distributed independently of the contents of televisual programs or reads out EPG from a recording medium such as a DVD-ROM, thereby acquiring the EPG.

In the first embodiment, a category need be selected from the program guide window every time. However, a selected category storage unit 8 for storing a category selected from the program guide window may be added to each of the audiovisual apparatuses 103a and 103b in FIG. 2. (FIG. 9).

When a category is selected, the identifier of the selected category is stored in the selected category storage unit 8. For example, when the viewer selects category “feature for children”, the selected category storage unit 8 stores identifier “category ID1” of the category.

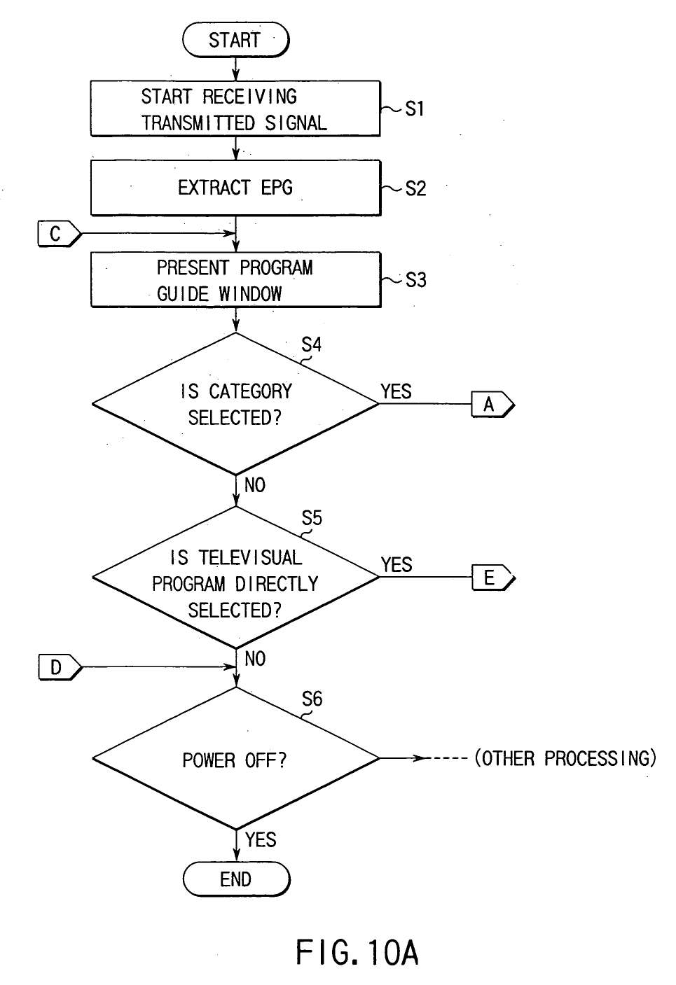

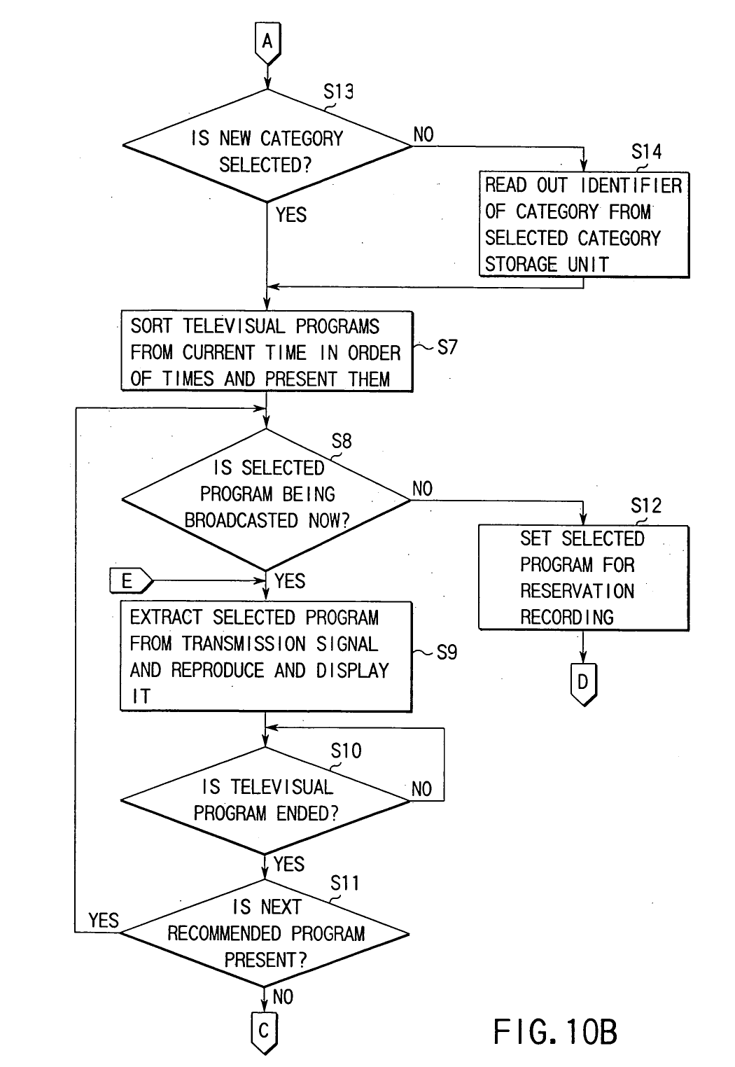

The processing operation of the audiovisual apparatus 103 having the arrangement shown in FIG. 9 will be described with reference to the flow charts shown in FIGS. 10A and 10B. The same reference numerals as in FIGS. 4A and 4B denote the same steps in FIGS. 10A and 10B, and only a different part will be described. In FIGS. 10A and 10B, step S4 in FIG. 4B is replaced with steps S13 and S14.

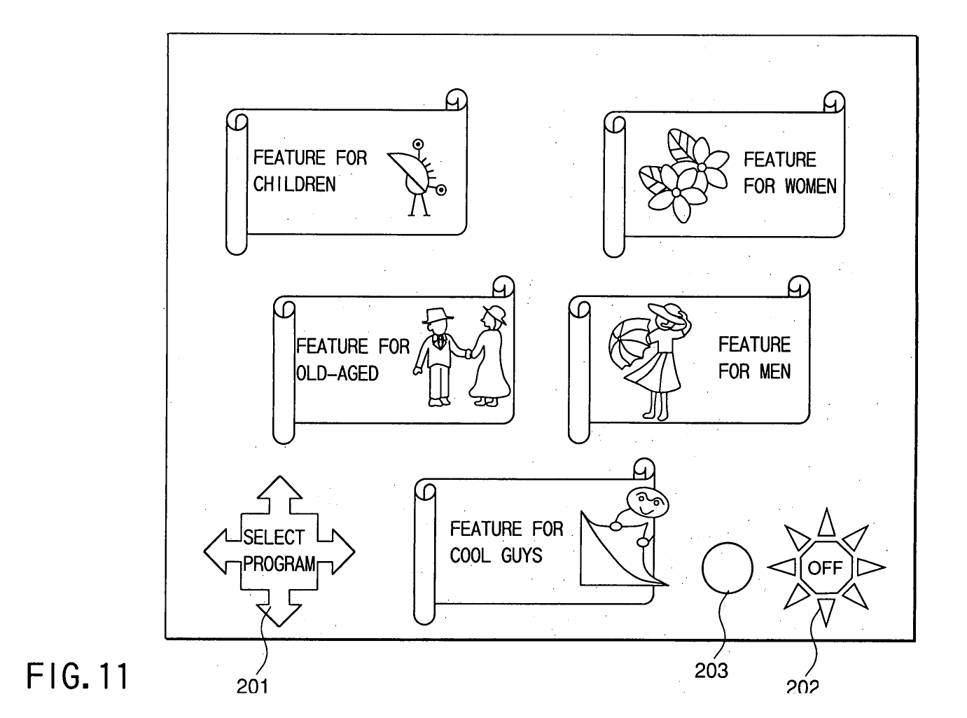

When the viewer selects a desired category on the program guide window as shown in FIG. 11, which is presented in step S3 (YES in step S13), the flow advances to step S7 to continue processing, as described above. On the other hand, in step S13, when a button 203 is selected on the program guide window using the selection unit 5 such as a remote controller (or when setting is done before presentation of the program guide window to validate a previously selected category without presenting the program guide window)., the flow advances to step S14 to read out the category identifier from the selected category storage unit 8. Then, the flow advances to step S7. Program data belonging to the category corresponding to the readout category identifier are re-sorted in the order of broadcasting times to generate a recommended program list as shown in FIG. 6, and the recommended program list is presented on the presentation unit 6.

When a previously selected category is stored in the selected category storage unit 8 and made valid instead of selecting the program category from the program guide window, the program selection operation of the viewer can be simplified.

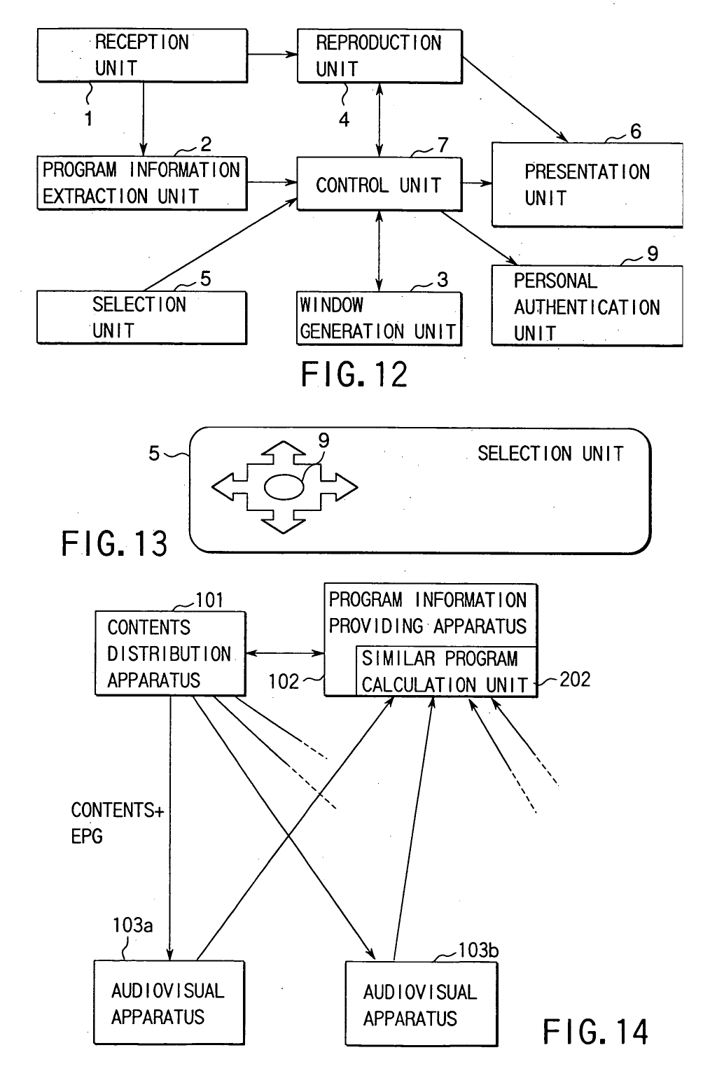

FIG. 12 shows still another arrangement of the audiovisual apparatus. The same reference numerals as in FIG. 2 denote the same parts in FIG. 12, and only a different portion will be described. In FIG. 12, a personal authentication unit 9 is added.

The personal authentication unit 9 authenticates a person by fingerprint authentication or the like. For example, when the selection unit 5 is formed from a remote controller, as shown in FIG. 13, the viewer necessarily holds it. Hence, the personal authentication unit 9 can be arranged at a portion where a finger of the viewer comes into contact with the remote controller.

When the personal authentication unit 9 is arranged as shown in FIG. 13, the viewer's fingerprint can be sampled for personal authentication by only holding the remote controller (selection unit 5) in his or her hand without performing any special operation for personal authentication. For this reason, the load on the viewer can be reduced.

For example, when one audiovisual apparatus 103 is used by a family, the personal authentication unit 9 authenticates the fingerprint of each family member. When the fingerprints of all family members are registered in the control unit 7 in advance in correspondence with sexes, ages, and tastes (sports, news, SF movies, and the like) of the members, the control unit 7 can control the window generation unit 3 to generate a program guide window that presents only categories meeting the age and taste of the viewer in accordance with the authentication result of the personal authentication unit 9.

In the first embodiment, the editor who generates EPG is fixed. For a long time, televisual programs classified into the same category may become stereotyped to reduce the advantage of EPG.

In the second embodiment, an EPG providing apparatus 102 collects information associated with televisual programs watched by a viewer (leans the taste of a viewer) and selects recommended programs in units of viewers on the basis of the similarity between televisual programs, thereby updating the EPG in units of viewers (more specifically, the recommended programs are added to the category in EPG).

FIG. 14 shows the overall arrangement of a broadcasting system according to the second embodiment of the present invention. FIG. 14 is different from FIG. 1 in that the EPG providing apparatus 102 has a similar program calculation unit 202 and collects information (e.g., contents IDs and program IDs) related to televisual programs selected in audiovisual apparatuses 103a and 103b from the audiovisual apparatuses 103a and 103b.

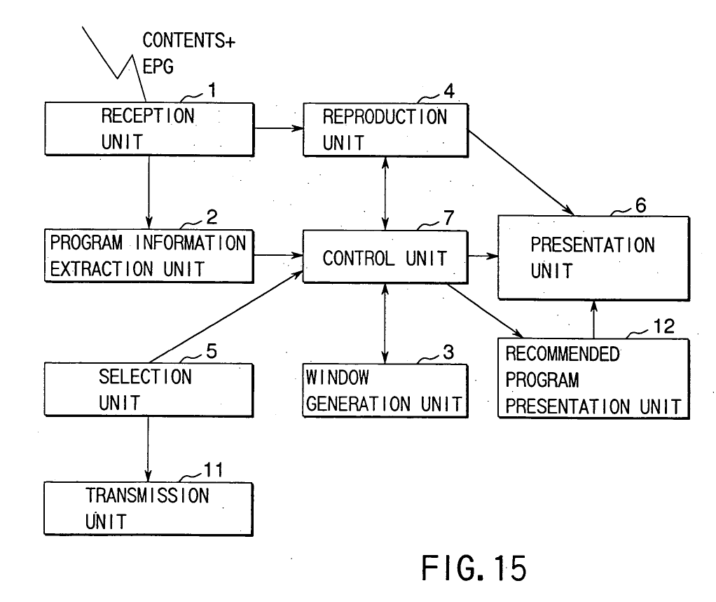

A contents distribution apparatus 101 distributes contents of televisual programs, event information (EIT: Event Information Table) attached to the contents, and keyword information associated with the contents of televisual programs (the pieces of information will be referred to as attached information hereinafter) through ground or satellite waves. The distributed contents of televisual programs and attached information are received by the EPG providing apparatus 102 for generating EPG and a reception unit 1 of each of the audiovisual apparatuses 103a and 103b each of which has an arrangement shown in FIG. 15 and set in a viewer house.

FIG. 15 shows the arrangement of each of the. audiovisual apparatuses 103a and 103b according to the second embodiment. Each of the audiovisual apparatuses 103a and 103b shown in FIG. 15 has a transmission unit 11 formed from a telephone line for transmitting information (e.g., category IDs and program IDs) associated with televisual programs selected from the program guide window by a selection unit 5 or directly selected without using the program guide window to the EPG providing apparatus 102, and a recommended program presentation unit 12 for presenting recommended programs selected on the basis of the calculation result from the similar program calculation unit 202 of the EPG providing apparatus 102 while discriminating the recommended programs from televisual programs contained in the old EPG.

When a desired program is selected by the selection unit 5 and watched, at least the identifier (program ID) for uniquely identifying the televisual program and the identifier (category ID) of the category to which the selected program belongs are transmitted to the EPG providing apparatus 102 through the transmission unit 11.

The EPG providing apparatus 102 has the similar program calculation unit 202 which calculates similar programs on the basis of the category ID and program ID sent from the audiovisual apparatus 103, event information (EIT) attached to the contents of a televisual program to be broadcasted from the contents distribution apparatus 101, and keyword information associated with the contents of televisual program (the pieces of information will be referred to as attached information hereinafter), which latter two are acquired from the contents distribution apparatus 101.

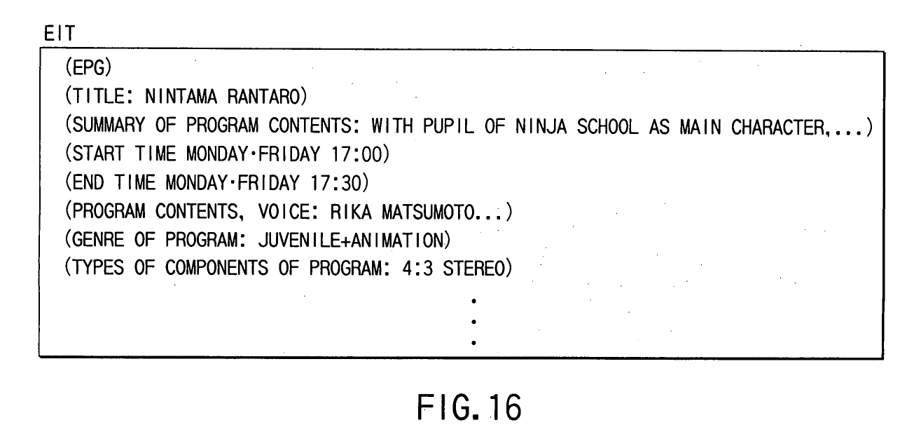

FIG. 16 shows an EIT of a program ID. To describe the EIT, a language prescribed as the standard of ARIB (Association of Radio Industries and Businesses) is used (“Program Array Information Used for Digital Broadcasting” ARIB STD-B10, 1.0 (1997)). For an actual description, HTML (HyperText Markup Language) is used. FIG. 16 schematically shows the description for the descriptive convenience.

The similar program calculation unit 202 uses, of the contents described in the EIT, description elements such as the program name, summary of program contents, program contents, and genre of the program as keywords and correlates the keywords with each other, thereby calculating the similarity in taste between viewers.

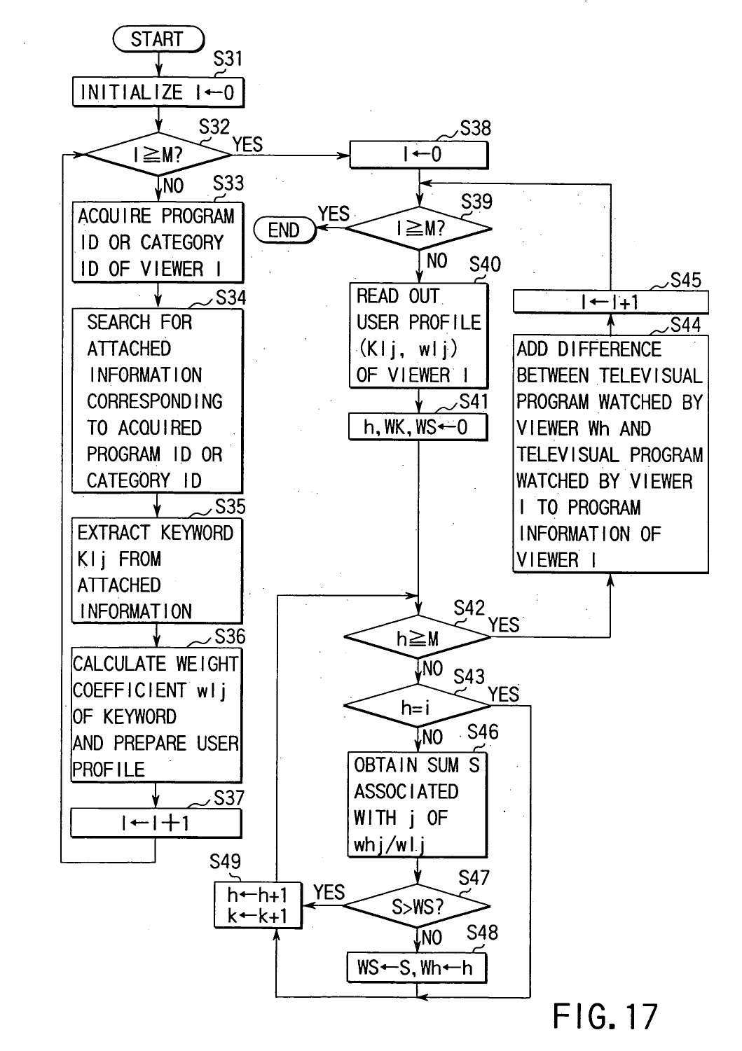

The similarity calculation procedure of the similar program calculation unit 202 will be described with reference to the flow chart shown in FIG. 17.

First, the program ID or category ID of a televisual program selected by a viewer (variable I), which is sent from the audiovisual apparatus 103, is acquired (step S33). When the program ID or category ID is collected from the viewer I, attached information corresponding to the acquired program ID or category ID is searched from already received attached information (e.g., EIT information) (step S34).

Keywords representing the feature of the contents of the televisual program are extracted from the searched attached information (EIT information) using an existing syntax analysis (step S35). An obtained keyword is represented by KIj (jth keyword obtained for a viewer corresponding to the variable I). A weight coefficient wIj of each keyword is calculated on the basis of correlation between keywords and appearance frequencies of keywords by referring to an independently prepared thesaurus (step S36). For example, when the keyword itself appears in the EIT information, “1” is added, and when a synonym of the keyword appears, a weight value (value smaller than “1”) determined on the basis of the correlation between the synonym and keyword is added, thereby obtaining the weight coefficient wIj of the keyword KIj. A set of KIj and wIj forms the user profile of the viewer I.

Preparation of user profiles of all viewers (e.g., M viewers) in steps S33 to S36 is ended (steps S37 and S32), the flow advances to step S38 to execute processing of M user profiles. For each viewer I, televisual programs (recommended programs) similar to the televisual program selected by the viewer I are selected, i.e., EPG of each viewer I is updated.

First, the prepared user profiles (KIj, wIj) of the viewers I are extracted one by one (step S40). Of the keywords KIj, N high-ranking keywords are selected in the descending order of wIj. It is determined whether the N high-ranking keywords KIj are included in keywords Khj of user profiles (Khj, whj) of remaining viewers h other than the viewer I. When the keywords are included, the weight coefficient whj of the keyword of the viewer h is divided by the weight coefficient wIj of the keyword of the viewer I. The quotients are added for all keywords of the viewer I, thereby obtaining a similarity S of the profile of the viewer h to the profile of the viewer I (steps S41 through S46). The similarity S is given by

$$S = {\sum }_{j} ( w h j / w I j )$$

To find the profile of another viewer h, which is most similar to the profile of the viewer I after the similarity S between the profile of the viewer I and that of another viewer h is obtained, the similarity S is compared to a variable WS that stores the largest value of the previously obtained similarities S (step S47). When the similarity S has a larger value than the variable WS, the similarity S is overwritten on the variable WS to update the variable WS, and the viewer h at that time is stored in a variable wh (step S48).

Steps S46 through S48 are performed for profiles of all viewers h other than the viewer I (steps S42, S43, and S49).

The taste of another viewer (to be referred to as a viewer Wh hereinafter) having a profile most similar to the profile of the viewer I is similar to that of the viewer I. That is, televisual programs selected by the viewer I and those selected by the viewer Wh are probably common. Of televisual programs watched by the viewer Wh, televisual programs that the viewer I has not watched yet are selected as recommended programs for the viewer I, and program data of the recommended. programs are transmitted to the audiovisual apparatus 103 of the viewer I (step S44). To transmit program data of recommended programs for each viewer, information containing at least the identifier of the viewer and program data of recommended programs for the viewer is added to common EPG for all viewers, multiplexed on the contents of televisual programs by the contents distribution apparatus 101, and distributed.

Steps S40 through S49 are performed for all viewers (steps S39 and S45).

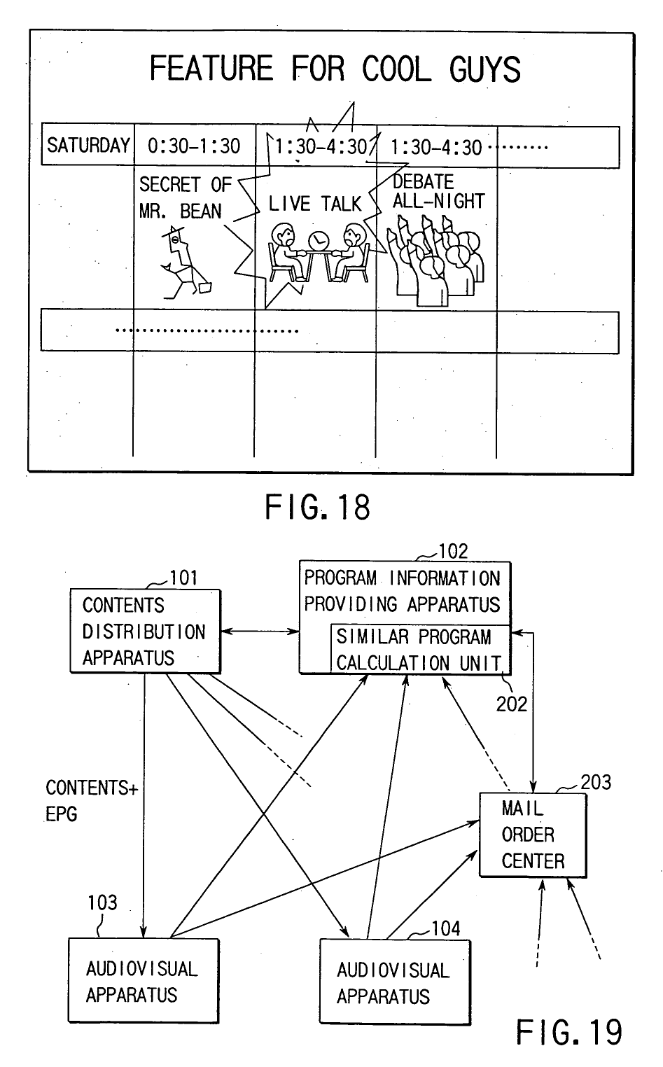

When EPG extracted by the EPG extraction unit 2 of the audiovisual apparatus 103 of the viewer I contains a recommended program for the viewer I, the recommended program presentation unit 12 encircles the recommended program (e.g., “live talk”) with a red line, as shown in FIG. 18, flickers the recommended program, or when another televisual program is scheduled in the same time, the recommended program is displayed ahead of the televisual program, thereby clearly presenting the recommended program by emphasis or special display.

The EPG of each viewer is preferably updated periodically, e.g., every day or every week.

As described above, according to the second embodiment, EPG to be distributed to each viewer is appropriately updated by adding a televisual program selected by another viewer having a taste similar to that of the viewer. For this reason, televisual programs classified into categories do not become stereotyped.

In the second embodiment, the similarity of televisual programs selected by viewers, i.e., similarity of tastes of viewers is calculated on the basis of EIT information attached to the contents of televisual programs. However, the present invention is not limited to this. For example, the closed caption (audio data is converted into character data and presented on the screen as a closed caption for auditory handicapped persons and the like. In the U.S.A., broadcasting stations have a legal obligation to transmit closed captions, and makers of image receiving apparatuses have a legal obligation to sell image receiver apparatuses having a closed caption presentation function) of a televisual program acquired from a program ID may be analyzed to extract keywords, and the similarity may be calculated on the basis of the keywords, as shown in FIG. 17.

In, e.g., Japan where closed caption display is not legalized, audio data in a transmitted signal may be recognized and converted into a text. Keywords may be extracted from this text to calculate the similarity, as shown in FIG. 17.

Alternatively, video data may be analyzed to calculate appearance time of each talent such as an actor/actress or singer. The weight coefficient of the talent can be calculated by adding a numerical value corresponding to the appearance time of a talent in place of a keyword, and the similarity can be calculated, as shown in FIG. 17.

Some of the above methods may be combined to calculate the similarity.

If processing shown in FIG. 17 is executed for all viewers subscribed to the service of the broadcasting system of the second embodiment, and the number of subscribers increases, the calculation load becomes too large. In such a case, two-step processing may be used: coarse masking is performed on the basis of the viewing time or genre, and then, similarity calculation based on keywords is executed for each viewer, as shown in FIG. 17.

In the second embodiment, a keyword is extracted from EIT information attached to the contents of a televisual program. However, the present invention is not limited to this. Recently, goods can be purchased on a network using, e.g., mail orders or virtual shops on the Internet. For example, as shown in FIG. 19, the EPG providing apparatus 102 may collect information (type such as cloth, food, or ticket, price, amount of purchase per month, and the like) of goods purchased on a network from a mail order center 201 which concentrically manages the goods information and use the information solely or together with keywords obtained from EIT information as a material for judging the taste of the viewer, thereby calculating the similarity by the similar program calculation unit 202, as shown in FIG. 17.

Alternatively, the latest keyword used by a viewer for search on the Internet may be used together with keywords obtained from EIT information to calculate the similarity, as shown in FIG. 17.

In the second embodiment, the contents of a televisual program and EPG are multiplexed and distributed from the contents distribution apparatus 101. However, as in the first embodiment, the contents of a televisual program and EPG may be independently distributed, or EPG may be recorded on a recording medium and distributed. In this case, the audiovisual apparatus 103 has an EPG acquisition unit 11 in place of the EPG extraction unit 2, and the reception unit 1 receives a broadcasting wave containing program contents other than EPG, as described in the first embodiment with reference to FIG. 8.

In the second embodiment, EPG is updated in units of viewers. However, the present invention is not limited to this. EPG commonly provided to all viewers may be updated. More specifically, on the basis of the similarity between televisual programs watched by viewers, televisual programs other than categories selected by another viewer having a taste similar to that of a viewer are added to the categories in EPG to be commonly provided to all viewers. Also, contents of transactions for goods purchases by mail orders may be collected. Televisual programs may be selected on the basis of the similarity between the taste of a viewer, which is determined from the contents of transactions. Televisual programs other than the categories may be added to the categories in EPG to be commonly provided to all viewers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An audiovisual apparatus for presenting televisual programs, comprising:
a personal authentication unit arranged at a portion where a finger of a viewer comes into contact with a remote controller;
a reception unit configured to receive an electronic program guide (EPG) in which televisual programs to be provided are classified into classified categories based on viewer features according to tastes of users, to allow selection of the televisual program in accordance with the classified categories based on viewer features, together with content information of a televisual program, or independently of the content information;
a generating unit configured to generate a program selection window for causing the user to select a desired program in accordance with the classified categories based on viewer features from the EPG received by said reception unit; and
a selection unit configured to cause the user to select a televisual program to be reproduced or recorded from the program selection window.

2. An apparatus according to claim 1, wherein said apparatus further comprises:
storage means for storing a classified category based on viewer features of the televisual program selected from the program selection window; and
means for causing the user to select the televisual program to be reproduced or recorded from televisual programs belonging to the stored classified category based on viewer features.

3. An apparatus according to claim 1, wherein
said generation unit generates a program selection window to present only classified categories based on viewer features suitable for the user in accordance with an authentication result of said personal authentication unit.

4. An apparatus according to claim 1, wherein said reception unit comprises at least one of:
means for receiving the EPG through one of a ground wave, a satellite wave, and a cable; and
means for receiving the EPG recorded on a recording medium.

5. An apparatus for providing additional services for televisual programs to be distributed by broadcasting, comprising:
a personal authentication unit arranged at a portion where a finger of a viewer comes into contact with a remote controller;
an electronic program guide (EPG) generation unit configured to generate an EPG in which televisual programs to be provided are classified into classified categories based on viewer features according to tastes of users to allow selection of a televisual program in accordance with the classified categories based on viewer features; and
an update unit configured to update the EPG on the basis of a similarity between televisual programs selected by the users.

6. An apparatus according to claim 5, wherein said update unit comprises:
means for adding televisual programs from other than a classified category based on viewer features selected by another user having a taste similar to that of a user to the EPG to be commonly provided to all the users, on the basis of the similarity between televisual programs selected by the users.

7. An apparatus according to claim 5, wherein said update unit comprises:
means for collecting contents of transactions for goods purchases by mail orders, and adding televisual programs from other than a classified category based on viewer features selected by another user having a taste similar to that of a user to the EPG to be commonly provided to all users, on the basis of the similarity between the taste of the user and a televisual program.

8. An apparatus according to claim 5, wherein said update unit comprises:
means for collecting contents of transactions for goods purchases by mail orders, selecting a televisual program on the basis of the similarity between the taste of a user and a televisual program, and adding televisual programs other than a classified category based on viewer features to the classified category based on viewer features in the EPG to be commonly provided to all users.

9. An apparatus according to claim 5, wherein said update unit comprises:
means for analyzing a closed caption to extract a keyword representing a feature of contents of a televisual program, thereby calculating the similarity.

10. An apparatus according to claim 5, wherein said update unit comprises:
means for recognizing audio data in a transmission signal of a televisual program, converting the audio data into a text, and extracting a keyword representing a feature of contents of the televisual program from the text, thereby calculating the similarity.

11. An apparatus according to claim 5, wherein said update unit comprises:
means for analyzing video data, calculating an appearance time of each performer, and accumulating a numerical value corresponding to the appearance time of the performer in place of a keyword representing a feature of contents of a televisual program to calculate a weight coefficient of the performer, thereby calculating the similarity.

12. An apparatus for providing additional services for televisual programs to be distributed by broadcasting, comprising:
a personal authentication unit arranged at a portion where a finger of a viewer comes into contact with a remote controller;
an electronic program guide (EPG) generation unit configured to generate an EPG in which televisual programs to be provided are classified into classified categories based on viewer features according to tastes of users to allow selection of a televisual program in accordance with the categories; and
an update unit configured to update the EPG on the basis of a similarity between a taste of a user and a televisual program, which is determined from contents of transactions of the user by communication.

13. A system for providing additional services, comprising:
an apparatus for providing additional services, including:
a personal authentication unit arranged at a portion where a finger of a viewer comes into contact with a remote controller;
electronic program guide (EPG) generation unit configured to generate an EPG in which televisual programs to be provided are classified into classified categories based on viewer features according to tastes of users to allow selection of a televisual program in accordance with the classified categories based on viewer features; and
an update unit configured to update the EPG on the basis of a similarity between televisual programs selected by the users; and
an audiovisual apparatus for presenting televisual programs, including:
a reception unit configured to receive the EPG provided from said apparatus for providing additional services, together with contents information of the televisual program or independently of the contents information;
a generation unit configured to generate a program selection window for causing a user to select a desired program in accordance with the classified categories based on viewer features on the basis of the EPG received by said reception unit; and
a selection unit configured to cause the user to select a televisual program to be reproduced or recorded from the program selection window.

14. A system according to claim 13, wherein said apparatus for providing additional services comprises:
similar-program calculation means for collecting information associated with selected programs from said audiovisual apparatus for presenting televisual programs to calculate similar programs, and said audiovisual apparatus for presenting televisual programs comprises:
recommended program presentation means for presenting the similar programs calculated by said similar program calculation means as recommended programs for the user.

15. A system according to claim 14, wherein said similar-program calculation means comprises:
means for collecting information of goods purchased on a network and calculating the similarity by using the information as a material for judging the taste of the user together with a keyword representing a feature of a televisual program, which is obtained from event information (EIT) attached to contents of the televisual program.

16. An article of manufacture, comprising:
a computer usable medium having computer readable program code means embodied therein for causing a user to select a provided televisual program in accordance with a taste of the user, the computer readable program code means in said article of manufacture comprising:
computer readable program code means or causing a computer to perform personal authentication of a user;
computer readable program code means for causing a computer to receive an electronic program guide (EPG) in which televisual programs to be provided are classified into classified categories based on viewer features according to tastes of users to allow selection of a televisual program in accordance with the classified categories based on viewer features;
computer readable program code means for causing the computer to generate a program selection window for causing the user to select a desired program in accordance with the classified categories based on viewer features from the received EPG; and
computer readable program code means for causing the computer to select a
televisual program to be reproduced or recorded from the program selection window.
